(19) United States
(12) Patent Application Publication
(10) Pub. No.: US 2015/0184771 A1
(43) Pub. Date: Jul. 2, 2015

(54) ELECTROMAGNET ASSISTED PRESSURE-ACTUATED VALVE

(71) Applicant: Ji Qiang Chen, Shanghai (CN)

(72) Inventor: Ji Qiang Chen, Shanghai (CN)

(73) Assignee: Norgren, Inc., Littleton, CO (US)

(21) Appl. No.: 14/409,854

(22) PCT Filed: Jul. 9, 2012
(86) PCT No.: PCT/CN2012/078344

§ 371 Date: Dec. 19, 2014

(51) Int. Cl. F16K 31/40; F16K 1/00; F16K 31/08

(52) U.S. Cl. CPC F16K 31/406; F16K 31/082; F16K 1/00

(57) ABSTRACT

An electromagnet assisted pressure-actuated valve (200) is provided. The electromagnet assisted pressure-actuated valve (200) includes a housing (201) with a pilot fluid pressure port (202), a first process fluid port (203), and a second process fluid port (204). The electromagnet assisted pressure-actuated valve (200) further includes a poppet member (205) movable within the housing (201) and a control chamber (220) in fluid communication with the pilot fluid pressure port (202) and with a first cross-sectional area (205a) of the poppet member (205). A permanent magnet (251) is provided that is coupled to one of the housing (201) or the poppet member (205). An electromagnet (250) is also provided that is coupled to one of the housing (201) or the poppet member (205) opposite the permanent magnet (251).

### TECHNICAL FIELD

The embodiments described below relate to, pressure-actuated valves, and more particularly, to an electromagnet assisted pressure-actuated valve.

### BACKGROUND OF THE INVENTION

Pilot actuated valve systems are generally known in the art and can be utilized in a wide variety of applications. In some applications, pilot valves are utilized to control a pilot fluid that is used to actuate a pressure-actuated main control valve. Pressure-actuated valves typically comprise a biasing piston or other element that actuates the valve when acted upon by a pressurized fluid supply. Generally, pilot valves control a pilot fluid that is at a pressure much less than a pressure of the operating process fluid controlled by the main control valve. The pilot fluid may comprise a pneumatic fluid, a hydraulic fluid, etc. The particular fluid used as the pilot fluid may depend on the particular application.

One particular use of pilot-actuated valve systems is in the control of process gas for blow molding systems. Blow molding is a generally known process for molding a preform part into a desired product. The preform is in the general shape of a tube with an opening at one end for the introduction of pressurized gas, typically air; however, other gases may be used. One specific type of blow molding is stretch blow molding (SBM). In SBM applications, a valve block provides both low and high-pressure gas to expand the preform into a mold cavity. The mold cavity comprises the outer shape of the desired product. SBM can be used in a wide variety of applications; however, one of the most widely used applications is in the production of Polyethylene terephthalate (PET) products, such as drinking bottles. Typically, the SBM process uses a low-pressure fluid supply along with a stretch rod that is inserted into the preform to stretch the preform in a longitudinal direction and radially outward and then uses a high-pressure fluid supply to expand the preform into the mold cavity. In many designs, each of the low-pressure and high-pressure fluid supplies can be controlled using a pressure-actuated valve. The resulting product is generally hollow with an exterior shape conforming to the shape of the mold cavity. The gas in the preform is then exhausted through one or more exhaust valves. This process is repeated during each blow molding cycle.

As can be appreciated, there is a general desire to increase the actuation speed as much as possible for each phase of the molding cycle. One area of the molding cycle that can be improved upon is the switching speed of the blow molding valves used for pressurizing the preform and subsequently exhausting the molded product. As mentioned above, in many situations, the blow molding valves comprise pressure-actuated valves. Such a valve is shown in FIG. 1.

FIG. 1 shows a pressure-actuated valve 100 according to the prior art. The pressure-actuated valve 100 includes a housing 101 including three ports 102, 103, and 104. The first port 102 comprises a pilot fluid pressure port. The pilot fluid pressure port 102 is selectively in fluid communication with a pilot fluid pressure supply 112 via a pilot valve 122 and a fluid line 125. The pilot valve 122 is biased by a spring 124 or the like in a first direction to supply pilot fluid pressure to the pilot port 102. Upon energizing the solenoid 123 of the pilot valve 122, the pilot valve 122 actuates to a second position to exhaust pressure within the pilot chamber 132.

The second port 103 comprises a process fluid inlet port and the third port 104 comprises a process fluid outlet port. The second port 103 can be in fluid communication with a process fluid supply 113 via a fluid line 114. The third port 104 can be in fluid communication with an end use, for example, a mold cavity of a SBM system holding a preform (not shown).

Movable within the housing 101 is a poppet member 105. The poppet member 105 includes a plurality of sealing members 106, 107. The poppet member 105 can form a fluid-tight seal with the housing 101 to close off the second port 103 from the third port 104. Along with the poppet member 105, the pressure-actuated valve 100 also includes a floating piston 108. The floating piston 108 includes sealing members 109, 110, which form fluid-tight seals with the sealing piston 105. The floating piston 108 can be included to reduce some of the cross-sectional area D₁ acted upon by the process fluid. This reduction allows a lower pilot fluid pressure to act on the cross-sectional area D₂ and still overcome the higher process fluid pressure.

The pilot fluid pressure supplied to the pilot port 102 is typically at a pressure that is much less than the pressure of the process fluid supply 113 being controlled and supplied to the preform. For example, during the blowing phase of the molding cycle, the process fluid supplied to the process fluid inlet port 103 often reaches approximately 40 bar (580 psi) while the pilot fluid pressure used to control the valve is only around approximately 7 bar (102 psi). While this difference in pressures is typically dealt with by increasing the cross-sectional area D₂ of the poppet member 105 acted upon by the pilot fluid pressure compared to the cross-sectional area D₁ acted upon by the process fluid, there is still room for improvement. More specifically, there is a desire to increase the speed at which the pressure-actuated valve can be actuated without having to increase the pilot fluid pressure, which would result in excessive costs. Although increasing the cross-sectional area D₂ may increase the force the pressure applies to the poppet member 105, the larger cross-sectional area results in a larger area for the pilot fluid pressure to pressurize, which may take an excessive amount of time.

The embodiments described below overcome these and other problems and an advance in the art is achieved. The embodiments described below provide a pressure-actuated valve including a permanent magnet and an electromagnet configured to provide a magnetic biasing force on the poppet member of the valve in addition to the pressure force. Therefore, the speed of actuation can be significantly increased without significantly increasing the cost of operation.

### SUMMARY OF THE INVENTION

An electromagnet assisted pressure-actuated valve is provided according to an embodiment. The electromagnet assisted pressure-actuated valve comprises a housing including a pilot fluid pressure port, a first process fluid port, and a second process fluid port. According to an embodiment, the electromagnet assisted pressure-actuated valve further comprises a poppet member movable within the housing and a control chamber in fluid communication with the pilot fluid pressure port and with a first cross-sectional area of the poppet member. According to an embodiment, the electromagnet assisted pressure-actuated valve further comprises a permanent magnet coupled to one of the housing or the poppet member and an electromagnet coupled to one of the housing or the poppet member opposite the permanent magnet.

A method for actuating an electromagnet assisted pressure-actuated valve is provided according to an embodiment. The method comprises a step of pressurizing a control chamber with a pilot fluid pressure to create a first pressure force, Fₚ₁ on a poppet member movable within a housing. According to an embodiment, the method further comprises a step of energizing an electromagnet with a first current having a first polarity while pressurizing the control chamber, wherein the electromagnet is coupled to one of the poppet member or the housing, to create a first magnetic force, F_{M} between the electromagnet and a permanent magnet coupled to one of the poppet member or the housing opposite the electromagnet. According to an embodiment, the method further comprises a step of actuating the poppet member in a first direction with the first pressure force, Fₚ₁, and the first magnetic force, F_{M}.

### ASPECTS

According to an aspect, an electromagnet assisted pressure-actuated valve comprises:
a housing including a pilot fluid pressure port, a first process fluid port, and a second process fluid port;
a poppet member movable within the housing;
a control chamber in fluid communication with the pilot fluid pressure port and with a first cross-sectional area of the poppet member;
a permanent magnet coupled to one of the housing or the poppet member; and
an electromagnet coupled to one of the housing or the poppet member opposite the permanent magnet.

Preferably, the first process fluid port is in fluid communication with a second cross-sectional area of the poppet member.

Preferably, the second cross-sectional area is less than the first cross-sectional area.

Preferably, the poppet member selectively blocks a fluid communication path between the first process fluid port and the second process fluid port.

Preferably, the electromagnet assisted pressure-actuated valve further comprises a floating piston movable within the housing and positioned at least partially within the poppet member.

Preferably, the pilot fluid pressure port is in fluid communication with a pilot valve, which selectively provides a fluid communication path with a pilot fluid pressure supply.

According to another aspect, a method for actuating an electromagnet assisted pressure-actuated valve comprises steps of:
pressurizing a control chamber with a pilot fluid pressure to create a first pressure force, Fₚ₁ on a poppet member movable within a housing;
energizing an electromagnet with a first current having a first polarity while pressurizing the control chamber, wherein the electromagnet is coupled to one of the poppet member or the housing, to create a first magnetic force, F_{M} between the electromagnet and a permanent magnet coupled to one of the poppet member or the housing opposite the electromagnet; and
actuating the poppet member in a first direction with the first pressure force, Fₚ₁, and the first magnetic force, F_{M}.

Preferably, the method further comprises a step of supplying a process fluid pressure to a first process fluid port formed in the housing to create a second pressure force, Fₚ₂, on the poppet member in a second direction substantially opposite the first direction.

Preferably, the pilot fluid pressure is at a lower pressure than the process fluid pressure.

Preferably, the pilot fluid pressure acts on a first cross-sectional area of the poppet member and the process fluid pressure acts on a second cross-sectional area of the poppet member, wherein the first cross-sectional area is greater than the second cross-sectional area.

Preferably, the method further comprises steps of:
exhausting the control chamber; and
energizing the electromagnet with a second current having a second polarity, substantially opposite the first polarity, while exhausting the control chamber to create a second magnetic force, F_{M′} substantially opposite the first magnetic force, F_{M}.

Preferably, the method further comprises a step of actuating the poppet member in the second direction with the second pressure force, Fₚ₂, and the second magnetic force, F_{M′}.

Preferably, the step of exhausting the control chamber comprises actuating a pilot valve to a second position to close a fluid communication path between a pilot fluid supply and the control chamber.

Preferably, the step of pressurizing the control chamber comprises actuating a pilot valve to a first position to open a fluid communication path between a pilot fluid supply and the control chamber.

### BRIEF DESCRIPTION OF THE DRAWINGS

FIG. 1 shows a prior art pressure-actuated valve.

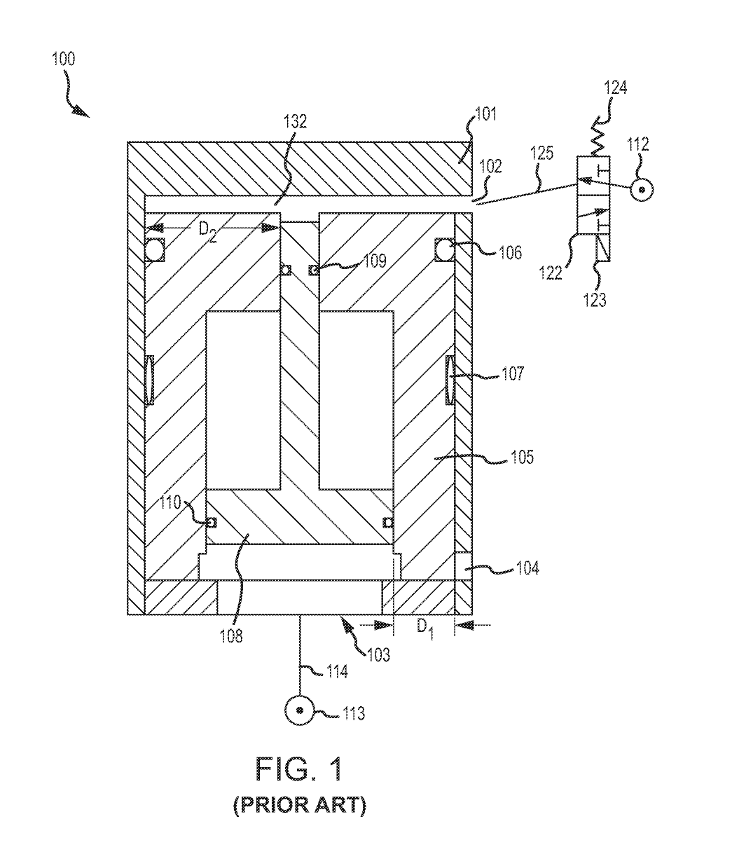

FIG. 2 shows a cross-sectional view of an electromagnet assisted pressure-actuated valve according to an embodiment.

FIG. 3 shows a timeline of the actuation of the electromagnet assisted pressure-actuated valve according to an embodiment.

### DETAILED DESCRIPTION OF THE INVENTION

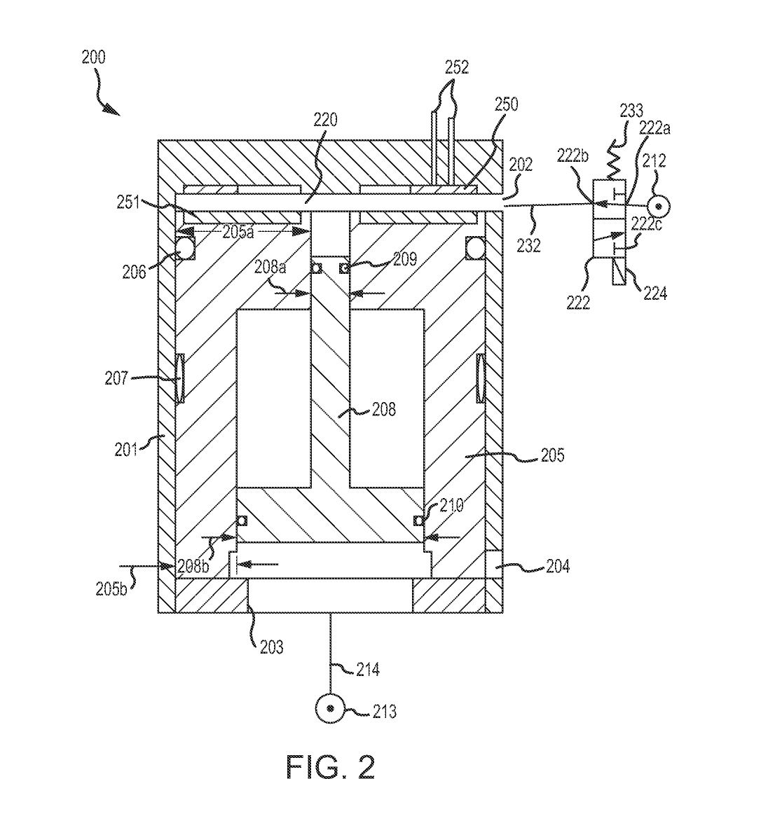

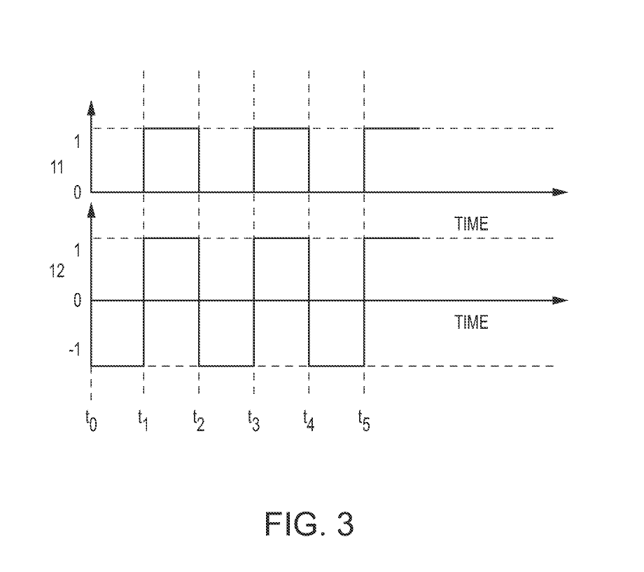

FIGS. 2-3 and the following description depict specific examples to teach those skilled in the art how to make and use the best mode of embodiments of a pressure-actuated valve. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the pressure-actuated valve. As a result, the embodiments described below are not limited to the specific examples described below, but only by the claims and their equivalents.

FIG. 2 shows a valve system 20 according to an embodiment. The valve system 20 can comprise an electromagnet assisted pressure-actuated valve 200 and a pilot valve 222. FIG. 2 shows a cross-sectional view of the electromagnet assisted pressure-actuated valve 200 according to an embodiment. The electromagnet assisted pressure-actuated valve 200 comprises a housing 201. The housing 201 can include a pilot fluid pressure port 202, a first process fluid port 203, and a second process fluid port 204. While only three fluid ports 202, 203, 204 are shown in FIG. 2, it should be appreciated that alternative embodiments may include more than three fluid ports.

According to an embodiment, the electromagnet assisted pressure-actuated valve 200 further comprises a poppet member 205. The poppet member 205 is movable within the housing 201. One or more sealing members 206, 207 can provide a fluid-tight seal between the poppet member 205 and the housing 201. According to an embodiment, the electromagnet assisted pressure-actuated valve 200 further includes a floating piston 208. As shown, sealing members 209, 210 can provide a fluid-tight seal between the floating piston 208 and the poppet member 205. According to an embodiment, the floating piston 208 can include a first cross-sectional area 208a and a second cross-sectional area 208b. The first cross-sectional area 208a is shown smaller than the second cross-sectional area 208b. According to an embodiment, the floating piston 208 can be oriented such that the first cross-sectional area 208a is proximate the pilot fluid pressure port 202 and the second cross-sectional area 208b is proximate the first process fluid port 203. According to an embodiment, the floating piston 208 can be provided to reduce the cross-sectional area of the poppet member 205 acted upon by the pilot fluid pressure or the process fluid pressure. According to an embodiment, the floating piston 208 is configured to provide a larger cross-sectional area 205a of the poppet member 205 remaining for pilot fluid pressure to act upon compared to the cross-sectional area 205b of the poppet member 205 that the process fluid acts upon. Therefore, the pilot fluid pressure may be lower than the process fluid pressure and still generate a higher biasing force on the poppet member 205 compared to the biasing force generated by the process fluid. It should be appreciated that in other embodiments, the first cross-sectional area 205a may be the same size or smaller than the second cross-sectional area 205b. Therefore, the claims that follow should not be limited to the embodiment shown. Although the floating piston 208 is shown positioned within the poppet member 205, in other embodiments, the floating piston 208 can surround the poppet member 205. In such a configuration, the outer surface of the floating piston 208 would form a fluid-tight seal with the housing 201. In yet another embodiment, the floating piston 208 may be omitted. Therefore, the particular configuration of the poppet member 205 should in no way limit the scope of the claims that follow.

In the embodiment shown, the pilot fluid pressure port 202 is used to supply and exhaust pilot fluid pressure from a control chamber 220. However, in other embodiments, an additional port may be provided and separate fluid ports may be used to supply and exhaust the pilot fluid pressure. According to an embodiment, the pilot fluid pressure port 202 is in fluid communication with a pilot valve 222. The pilot valve 222 can selectively provide fluid communication between the pilot fluid pressure port 202 and a pilot fluid supply 212. The pilot fluid may comprise a liquid, a gas, or a combination thereof. Although the pilot valve 222 is shown as comprising a 3/2 valve, other configurations may be utilized without departing from the scope of the present embodiment.

According to the embodiment shown, the pilot valve 222 comprises a first fluid port 222a, which is in fluid communication with the pilot fluid supply 212. According to an embodiment, the pilot valve 222 further comprises a second fluid port 222b, which is in fluid communication with the pilot fluid pressure port 202 of the electromagnet assisted pressure-actuated valve 200 via a fluid line 232. The second fluid port 222b is also selectively in fluid communication with a third fluid port 222c of the pilot valve 222. According to an embodiment, the third fluid port 222c can be open to exhaust. However, in other embodiments, the third fluid port 222c may be in fluid communication with a pressure recovery system as is generally known in the art.

In the embodiment shown, the pilot valve 222 can be actuated to a first position using a biasing member 233. It should be appreciated, that the biasing member 233 may be replaced with a solenoid, a pilot port, a piezoelectric element, etc. The particular method used to actuate the pilot valve 222 to the first position should in no way limit the scope of the present embodiment. According to an embodiment, in the first position, the pilot valve 222 selectively opens a fluid communication path between the first fluid port 222a and the second fluid port 222b. Consequently, pilot fluid is supplied from the pilot fluid supply 212 to the pilot fluid pressure port 202 of the electromagnet assisted pressure-actuated valve 200. As pilot fluid begins to pressurize the control chamber 220, a first pressure force Fₚ₁ is applied to the poppet member 205 to bias the poppet member 205 in a first direction towards a first position. In the orientation shown in FIG. 2, the first direction is down. As can be appreciated, the first pressure force Fₚ₁ is created as a result of the pilot fluid having a pressure P₁ acting on the first cross-sectional area 205a of the poppet member 205.

As mentioned above, the first process fluid port 203 can receive a process fluid from a process fluid supply 213 via a fluid line 214. The process fluid may comprise a gas, a liquid, or a combination thereof. According to one embodiment, the process fluid line 214 may fluidly couple the process fluid supply 213 with the first process fluid port 203 in a continuous manner, i.e., no valve may be present. However, in other embodiments, a separate valve may be used. As a result of the process fluid reaching the first process fluid port 203, a second pressure force Fₚ₂ is applied to the poppet member 205. The second pressure force Fₚ₂ is due to the process fluid having a pressure P₂ acting on the second cross-sectional area 205b. As can be appreciated, the second pressure force Fₚ₂ will provide a second biasing force, which is in a second direction, on the poppet member 205. In the configuration shown in FIG. 2, the second direction is up.

As those skilled in the art will recognize, once Fₚ₁>Fₚ₂, the poppet member 205 will be actuated in the first direction, and the poppet member 205 will close off the first process fluid port 203 from the second process fluid port 204. Conversely, when Fₚ₂>Fₚ₁, the poppet member 205 will be actuated in the second direction, and the poppet member 205 will open the first process fluid port 203 to the second process fluid port 204 and the process fluid may be supplied to the end use.

Until now, the operation of the valve 200 has been substantially the same as the valve 100 of the prior art. As mentioned above, the speed of actuating the poppet member 205 may not be adequate in some situations and there may be a desire to increase the speed at which the poppet member 205 can be moved from the first position (shown) to a second position, where the first process fluid port 203 is open to the second process fluid port 204.

According to an embodiment, the electromagnet assisted pressure-actuated valve 200 comprises one or more electromagnets 250 and one or more permanent magnets 251. Although only one electromagnet 250 and one permanent magnet 251 are shown, it should be appreciated that in other embodiments, multiple electromagnets and permanent magnets may be utilized. According to an embodiment, the electromagnet 250 is coupled to one of the housing 201 or the poppet member 205. According to an embodiment, the electromagnet 250 is coupled to the housing 201 proximate the control chamber 220 defined by the housing 201 and the poppet member 205. According to an embodiment, the one or more permanent magnets 251 are coupled to one of the housing 201 or the poppet member 251 opposite the electromagnet 250. For example, if the electromagnets 250 are coupled to the housing 201, then the permanent magnets 251 will be coupled to the poppet member 205. Conversely, if the electromagnets 250 are coupled to the poppet member 205, then the permanent magnets 251 will be coupled to the housing. The one or more permanent magnets 251 may be coupled to the poppet member 251 and exposed to the control chamber 220, for example. However, in other embodiments, the one or more permanent magnets 251 and the one or more electromagnets 250 may be exposed to the first process fluid port 203 rather than the control chamber 220. Although the electromagnet 251 is described as coupled to the housing 201 and the magnet 251 is described as coupled to the poppet member 205 in the embodiment that follows, the two components could be switched, i.e., the magnet 251 could be coupled to the housing 201 and the electromagnet 250 could be coupled to the poppet member 205. However, the configuration shown allows for easier wiring of the electromagnet 250 to the electrical contacts 252 as movement of the poppet member 205 does not have to be accounted for in the wiring.

According to an embodiment, power may be supplied to the electrical contacts 252 to energize the electromagnet 250 in order to either attract the one or more permanent magnets 251 or repel the one or more permanent magnets 251. The attraction and repulsion can be controlled based on the polarity of the current supplied to the electrical contacts 252, for example. For example, a positive polarity may attract the permanent magnet 251 to the electromagnet 250 while a negative polarity may repel the permanent magnet 251 from the electromagnet 250. As those skilled in the art will readily appreciate, the attraction/repulsion can be used in unison with the pilot fluid pressure to speed up the movement of the poppet member 205. The control of the electromagnet 250 and the pilot valve 222 can be illustrated by comparing the current supplied to each of the components on a timeline as in FIG. 3.

FIG. 3 shows a chart of the currents supplied to the pilot valve 222 and the electromagnet 250 according to an embodiment. In the embodiment shown in FIG. 3, I₁ is the current supplied to the pilot valve 222 and more specifically, to the solenoid 224 of the pilot valve 222 while I₂ is the current supplied to the electromagnet 250.

From approximately t₀−t₁, there is no power supplied to the solenoid 224 and thus, the biasing member 233 biases the pilot valve 222 to the first position. As discussed above, in the first position, the pilot valve 222 supplies pilot fluid pressure to the pilot fluid pressure port 202 to pressurize the control chamber 220. Therefore, the pilot fluid pressure provides the first pressure force, Fₚ₁. Substantially simultaneously, a first current is supplied to the electromagnet 250. According to an embodiment, the first current comprises a negative current. The negative current, −I₂, results in the permanent magnet 251 being repelled from the electromagnet 250. Because the permanent magnet 251 is coupled to the poppet member 205, the poppet member 205 is likewise repelled. The repulsion results in an additional magnetic biasing force F_{M} being applied to the poppet member 205. The magnetic biasing force F_{M} is also in the first direction. Therefore, between times t₀−t₁, the net force applied to the poppet member 205 is Fₚ₁+F_{M}−Fₚ₂. As long as (Fₚ₁+F_{M})>Fₚ₂, the poppet member 205 will be actuated to the first position. Therefore, the poppet member 205 is actuated towards the first position with a greater force than in the prior art, which only involved Fₚ₁−Fₚ₂. Furthermore, the poppet member 205 is actuated towards the first position faster than in the prior art.

According to the prior art, which did not include the electromagnet 250, actuation of the poppet member 205 was delayed by the actuation time of the solenoid 224 and the time required to pressurize the control chamber 220. In contrast, the poppet member 205 may begin moving after the actuation time of the electromagnet 250 and may not require full pressurization of the control chamber 220. In other words, the magnetic biasing force F_{M} may provide enough of a biasing force to the poppet member 205 that the poppet member 205 can begin to move before the pressure in the control chamber 220 reaches the threshold pressure required to overcome the second pressure force, Fₚ₂. It should also be appreciated that the additional magnetic biasing force F_{M} may allow the first cross-sectional area 205a to be smaller than or equal to the second cross-sectional area 205b and the poppet member 205 can still be actuated.

From approximately time t₁−t₂, there is a current, I₁, applied to the solenoid 224. Although the current, I₁, is shown as positive, it could be negative. Therefore, power is supplied to the solenoid 224 to actuate the pilot valve 222. Consequently, the pilot valve 222 is actuated to the second position. In the second position, the pressure within the control chamber 220 is exhausted through the third fluid port 222c. As can be seen, substantially simultaneously, a second current, I₂ is supplied to the electromagnet 205. According to an embodiment, the second current, I₂, is substantially opposite the first current. In other words, while the first current, −I₂, supplied to the electromagnet 250 was a negative current, the second current, I₂, can be positive. The positive current, I₂, attracts the permanent magnet 251 towards the electromagnet 250 with a force, F_{M′}. Therefore, from times t₁−t₂, the poppet member 205 is biased upwards towards the second position with a combined force of Fₚ₂+F_{M′}. The additional force F_{M′} can increase the actuation speed of the poppet member 205 towards the second position to open the fluid communication path between the first process fluid port 203 and the second process fluid port 204 faster than in the prior art, which only involved Fₚ₂.

The cycle between actuating the poppet member 205 towards the first and second positions continues as illustrated between times t₂−t₃, t₃−t₄, and t₄−t₅. As can be appreciated, between each time set, the valve 200 is actuated to the first or the second position.

According to an embodiment, the electromagnet 250 and the solenoid 224 may be electrically coupled to independent circuits such that each component may be energized independently. According to another embodiment, the electromagnet 250 may be electrically coupled to the same circuit as the solenoid 224. Such a configuration may eliminate the need for the biasing member 233. Rather, a first current, −I, may be applied to both the solenoid 224 and the electromagnet 250 to bias the poppet member 205 in the first direction. For example, a negative current, −I, can actuate the pilot valve 222 to the first position and create a repulsion between the electromagnet 250 and the permanent magnet 251. Conversely, a second current, I, may be applied to both the solenoid 224 and the electromagnet 250 to bias the poppet member 205 in the second direction by actuating the pilot valve 222 to the second position and creating an attraction between the electromagnet 250 and the permanent magnet 251. Electrically coupling the solenoid 224 and the electromagnet 250 to the same electrical circuit may reduce wiring and ensure that the two components are actuated substantially simultaneously.

In use, the electromagnet assisted pressure-actuated valve 200 can be actuated to control a fluid flow between the first process fluid port 203 and the second process fluid port 204. According to an embodiment, the pilot valve 222 can be actuated to a first position to supply a pilot fluid pressure to the control chamber 220. The pilot fluid pressure in the control chamber 220 applies a first pressure force, Fₚ₁ to the poppet member 205. While the control chamber 220 is pressurized, a first current can be supplied to the electromagnet 250 to create a first magnetic biasing force, F_{M}, between the electromagnet 250 and the permanent magnet 251. According to an embodiment, the first magnetic biasing force, F_{M}, comprises a repulsive force. Due to the first pressure force, Fₚ₁, of the pilot fluid pressure within the control chamber 220 acting across the cross-sectional area 205a of the poppet member and the magnetic biasing force, F_{M}, of the electromagnet 250, the poppet member 205 is biased in the first direction towards the first position. This position is shown in FIG. 2.

In order to actuate the poppet member 205 towards the second position (up as shown), the pilot valve 222 can be actuated to a second position and a second current can be applied to the electromagnet 250. According to an embodiment, actuation of the pilot valve 222 can occur due to energizing the solenoid 224. According to an embodiment, the second current applied to the electromagnet 250 can comprise a positive current. As the pilot valve 222 is actuated to the second position and the second current is applied to the electromagnet 250, the pressure within the control chamber 220 is exhausted and a second magnetic biasing force, F_{M′} is applied to the poppet member 205. The second magnetic biasing force, F_{M′} and the second pressure force, Fₚ₂ caused by the process fluid acting across the cross-sectional area 205b, the poppet member 205 moves in the second direction.

As can be appreciated, the magnetic biasing forces, F_{M} and F_{M′} can aid in decreasing the response time of actuation of the poppet member 205 and speed the movement of the poppet member 205.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other valves, and not just to the embodiments described above and shown in the accompanying figures. Accordingly, the scope of the embodiments described above should be determined from the following claims.

We claim:

1. An electromagnet assisted pressure-actuated valve (200), comprising:
a housing (201) including a pilot fluid pressure port (202), a first process fluid port (203), and a second process fluid port (204);
a poppet member (205) movable within the housing (201);
a control chamber (220) in fluid communication with the pilot fluid pressure port (202) and with a first cross-sectional area (205a) of the poppet member (205);
a permanent magnet (251) coupled to one of the housing (201) or the poppet member (205); and
an electromagnet (250) coupled to one of the housing (201) or the poppet member (205) opposite the permanent magnet (251).

2. The electromagnet assisted pressure-actuated valve (200) of claim 1, wherein the first process fluid port (203) is in fluid communication with a second cross-sectional area (205b) of the poppet member (205).

3. The electromagnet assisted pressure-actuated valve (200) of claim 2, wherein the second cross-sectional area (205b) is less than the first cross-sectional area (205a).

4. The electromagnet assisted pressure-actuated valve (200) of claim 1, wherein the poppet member (205) selectively blocks a fluid communication path between the first process fluid port (203) and the second process fluid port (204).

5. The electromagnet assisted pressure-actuated valve (200) of claim 1, further comprising a floating piston (208) movable within the housing (201) and positioned at least partially within the poppet member (205).

6. The electromagnet assisted pressure-actuated valve (200) of claim 1, wherein the pilot fluid pressure port (202) is in fluid communication with a pilot valve (222), which selectively provides a fluid communication path with a pilot fluid pressure supply (212).

7. A method for actuating an electromagnet assisted pressure-actuated valve, comprising steps of:
pressurizing a control chamber with a pilot fluid pressure to create a first pressure force, Fₚ₁ on a poppet member movable within a housing;
energizing an electromagnet with a first current having a first polarity while pressurizing the control chamber, wherein the electromagnet is coupled to one of the poppet member or the housing, to create a first magnetic force, F_{M} between the electromagnet and a permanent magnet coupled to one of the poppet member or the housing opposite the electromagnet; and
actuating the poppet member in a first direction with the first pressure force, Fₚ₁, and the first magnetic force, F_{M}.

8. The method of claim 7, further comprising a step of supplying a process fluid pressure to a first process fluid port formed in the housing to create a second pressure force, Fₚ₂, on the poppet member in a second direction substantially opposite the first direction.

9. The method of claim 8, wherein the pilot fluid pressure is at a lower pressure than the process fluid pressure.

10. The method of claim 9, wherein the pilot fluid pressure acts on a first cross-sectional area of the poppet member and the process fluid pressure acts on a second cross-sectional area of the poppet member, wherein the first cross-sectional area is greater than the second cross-sectional area.

11. The method of claim 8, further comprising steps of:
exhausting the control chamber; and
energizing the electromagnet with a second current having a second polarity, substantially opposite the first polarity, while exhausting the control chamber to create a second magnetic force, F_{M′} substantially opposite the first magnetic force, F_{M}.

12. The method of claim 11, further comprising a step of actuating the poppet member in the second direction with the second pressure force, Fₚ₂, and the second magnetic force, F_{M′}.

13. The method of claim 11, wherein the step of exhausting the control chamber comprises actuating a pilot valve to a second position to close a fluid communication path between a pilot fluid supply and the control chamber.

14. The method of claim 7, wherein the step of pressurizing the control chamber comprises actuating a pilot valve to a first position to open a fluid communication path between a pilot fluid supply and the control chamber.
